(19) United States
(12) Patent Application Publication
(10) Pub. No.: US 2004/0134672 A1
(43) Pub. Date: Jul. 15, 2004

(54) Better structure of fire-fighting bomb

(76) Inventor: Wen-Tuno Tsao, Banchiau City (TW)

Correspondence Address: TROXELL LAW OFFICE PLLC, SUITE 1404, 5205 LEESBURG PIKE, FALLS CHURCH, VA, 22041, US

(21) Appl. No.: 10/340,757

(22) Filed: Jan. 13, 2003

(51) Int. Cl. A62C 11/00

(52) U.S. Cl. 169/58

(57) ABSTRACT

A better structure of fire-fighting bomb which refers on the moment of producing huge amounts of gases on explosion by the gunpowder room on shooting the bomb, by utilizing the pressure of huge gases to better the operation of said fire-fighting bomb which increases the mutual reaction time of chemical reactants in the internal space of the bomb to complete the reaction and elevate the efficiency of inhibiting combustion substances produced by chemical reactions such as the liquid containing huge amounts of carbon dioxide bubble; wherein when the bomb hits the target, the inhibiting combustion substance produced by the bomb is sprayed out to the target fire source to achieve the purpose of extinction of fire.

### BACKGROUND OF THE INVENTION

1. Field of the Invention

This invention relates to a better structure of fire-fighting bomb, especially a better structure of the fire-fighting bomb used specially aiming at the fire location which is hard to deal with.

2. Description of the Prior Art

Fire is the disaster which is hard to be predicted in human life's whereas it causes the financial loss even causes the death or hurt of people, wherein it is also the burden of social-cost in order to fire-fighting, if the golden time of fire-fighting is lost, it may causes doubles of loss; since its un-predictability of fire, sometimes the fire happened in the mountain is hard to fight since there is inconvenience of traffic in the mountain and the water of the fire-fighting staffs is hard to enter into the area, so it is a must for the fire-fighting staffs to go into the fire area to fire-fighting by carrying on some simple tools or some water bags which are little quantity with heavy weight; if the road path of the mountains is un-straight for going, it is often that there is delay for time of fire-fighting. When they receives the message which has lost the golden time of fire-fighting, and often the golden time for fire-fighting has been lost since the delay of reaching the area of fire; often it is the method that the fire-fighting staffs have to create a fire-fighting area around the fire area and to avoid the expansion of the fire range to control the fire loss; however, it is no way to deal with the on-fire area.

From this it is understood that there still are many drawbacks on the above-mentioned conventional object which is not a fine design and is required to be better.

The inventor of this invention thinks to better and study for many years due to each drawback derived by the above-mentioned fire-fighting bomb and finally successfully completes the better structure of this invention.

### SUMMARY OF THE INVENTION

The purpose of this invention is to provide a better structure of fire-fighting bomb which utilizes the principle of shoot to aim at the fire source of the shoot and to send the fire-fighting bomb exactly into the fire source center of the fire area; next to spray the around of the fire source with the chemical substances inhibiting combustion with the advantageous position in proximity with the fire source to extinguish the fire source and achieve the purpose of fire-fighting.

Another purpose of this invention is to reduce the chance of dangerous happened such that many fire-fighting staffs do not have to take the risk of fire-fighting by entering into the fire area directly to protect the life and the fire-fighting staffs which also elevates the accuracy and efficiency of fire-fighting.

The better structure of fire-fighting which achieves the above-mentioned purpose of invention refers to the mechanism which, by utilizing the pressure of bulk gas to operate said fire-fighting bomb better structure which increases the mutual reaction time of the chemical reactant inside the bomb so that the reaction is more complete; thus it elevates the efficiency of the inhibiting combusting substance produced by chemical reactions such as the liquid containing large amounts of carbon dioxide bubble; wherein the bomb hits the object, it ejects the substances that inhibits combustion reacted inside the bomb and sprays to the target fire source to achieve the purpose of fire-fighting.

### BRIEF DESCRIPTION OF THE DRAWINGS

The drawings disclose an illustrative embodiment of the present invention which serves to exemplify the various advantages and objects hereof, and are as follows:

FIG. 1 is the cross-sectional view of the bomb of this invention;

FIG. 2 is the tail view of the bomb of this invention;

FIG. 3 is the partial enlarged cross-sectional view of the axial piston and the bar inside the bomb head of this invention;

FIG. 4 is the motion illustration view of the rear cap of the strong acid of the gas inlet pipeline of this invention.

### DETAILED DESCRIPTION OF THE PREFERRED EMBODIMENT

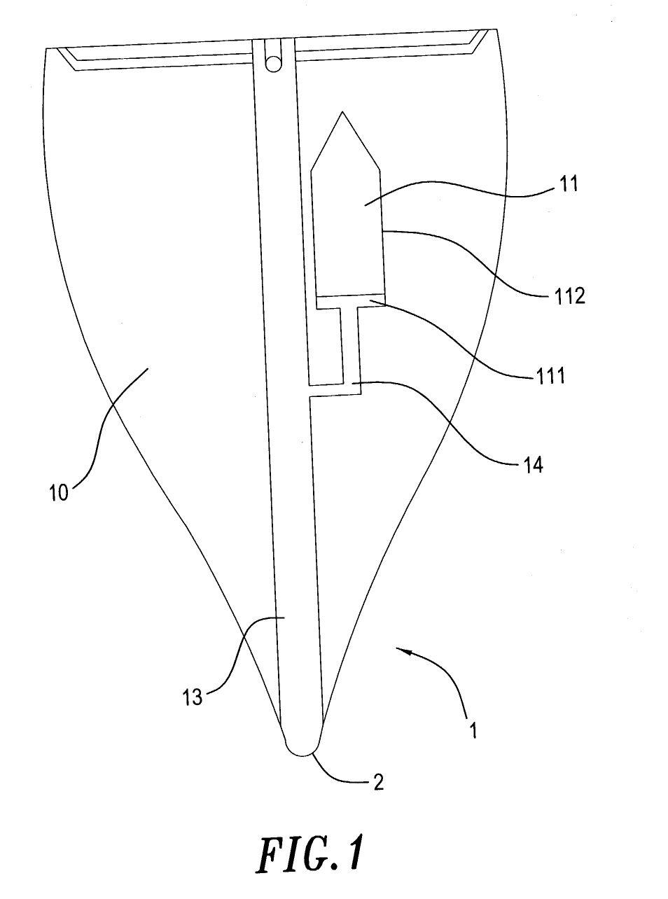

Please refer to FIG. 1, the better structure of fire-fighting bomb of this invention is designed inside a bomb head 1, comprising an axial conduct 13 of extending from said bomb head 1 to one of the tail along with the central axial, an internal space 10 of containing NAHCO3, and a strong base room 11 containing the strong base chemical substance, said strong base room 11 is composite by a bottom cap 111 and a rear cap 112 to be a container free to be open and close, and is, connected with said axial conduct 13 with an inlet conduct 14 to form an inlet pipeline which makes the gas enter into said strong base room 11 from said axial conduct 13 along said inlet conduct 14; besides, there convexes a bar 2 settled in front end of the central axial of said bomb head 1.

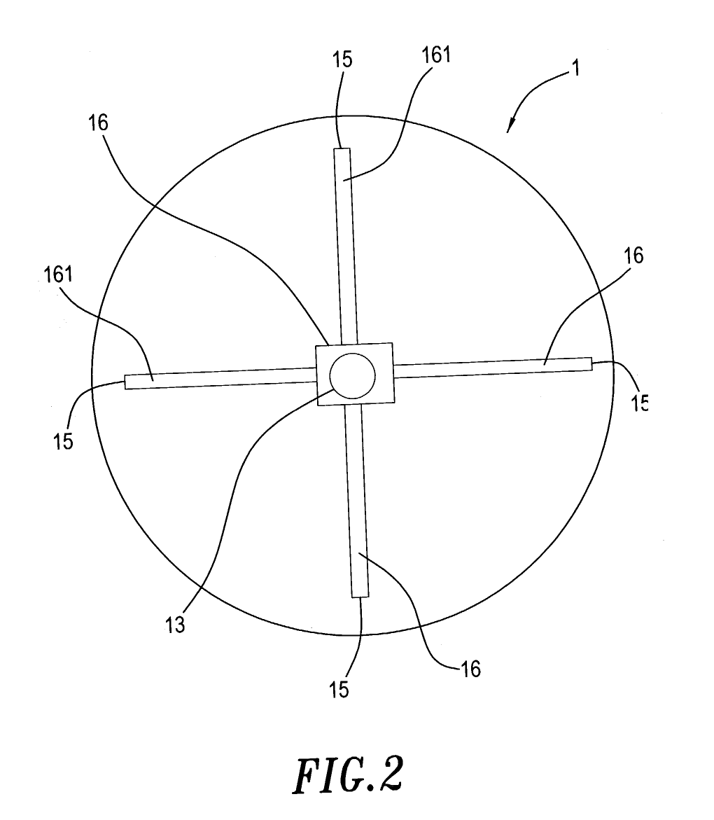

Please refer to FIG. 2, there settles an inlet 15 and outlet equipment 16 in connection with said axial conduct 13 on the tail of said bomb head 1, said outlet equipment 16 contains a plurality of outlet conducts 161.

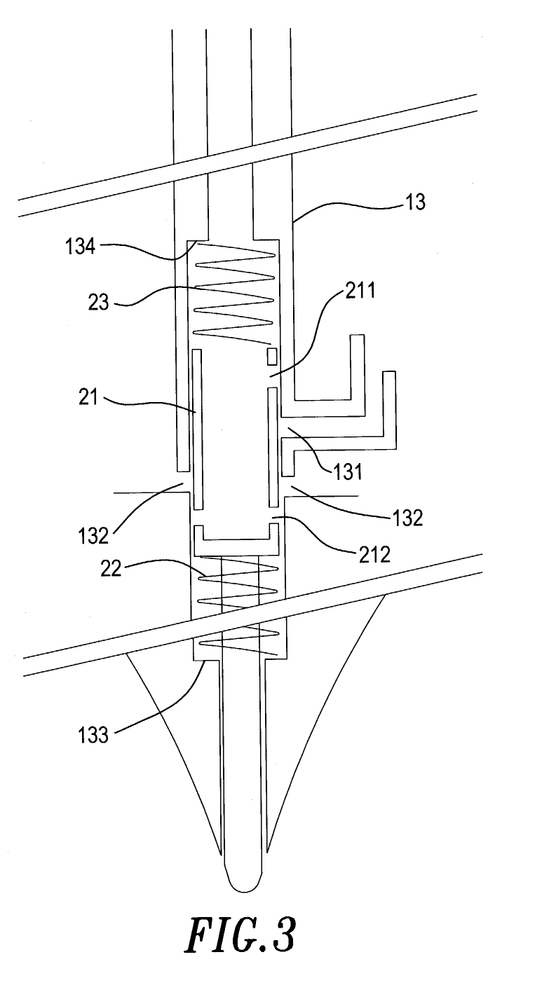

Please refer to FIG. 3, as shown in said partial cross-sectional view, on the axial conduct 13 there settles a gas inlet 131 and a carbon dioxide outlet 132; besides, there designs a front static stop structure 134 and a rear static stop structure 134 on the internal pipe wall of said axial conduct 13, and there accommodates an axial piston position 21 with the cavity structure on the space between said front static stop structure 133 and said rear static stop structure 134, there settles a gas outlet piston 211 and a carbon dioxide inlet piston 212 on said axial piston 21; by means of a position spring 23 to static stop on said front static stop structure 133 and a re-retrace spring 22 static stop on said rear static stop structure 133 so that said axial piston 21 is held in elastic equilibrium with the space of two static stop structure which makes said gas outlet piston 211 separates with said gas inlet 131 and said carbon dioxide piston 212 and said carbon dioxide outlet 132 and achieves the purpose of gas seal.

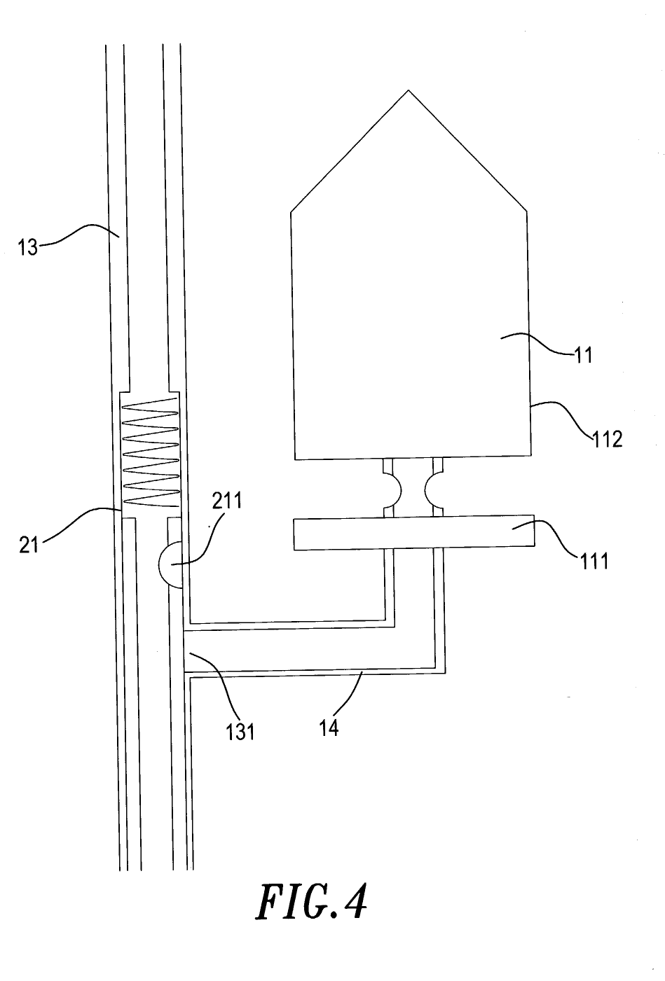

Please refer to FIG. 4, on the moment of explosion of the gunpowder room when shooting the fire-fighting bomb, since the huge gas produced due to explosion entering from the inlet 15 on the tail of said bomb head 1 along with said axial conduct 13 to perfuse into said axial piston 21, and pushes forward said axial piston 21 due to the pressure of gas so that said gas outlet piston 211 forms gas pipeline with gas inlet 131 along with said inlet conduct 14 so that huge amounts of gases enters into said strong acid room 11 through this pipeline, it opens the rear cap 112 of said strong base room 11 due to the pressure of inlet so that the strong acids overflows out of said strong acid room 11 and reacts with NaOH inside said internal room 10 full around whereas the gases also enters into the internal which increases the gas pressure of the internal space 10; the above-mentioned motion will be proceeded after the moment of explosion of the room fire-fighting bomb so that when said axial piston 21 is pushed by large gases and compresses said re-entrance spring 22 to produce the restore force (please refer to FIG. 3, it finally bounce onto the original equilibrium position before explosion so that the close circuit of the pipeline is formed again and close the reaction space; during said period, the strong acid reactants reacts fully with NaOH fully to produce the substances that inhibits combustion such as the liquid containing huge amounts of carbon dioxide bubble so that said bomb head 1 hits the target object to force said bar 2 to push said axial piston 21 so that said carbon dioxide inlet piston 212 is in alignment with the position of said carbon dioxide outlet 132 to form the outlet pipeline such that said internal space 10 produces the pressure larger than outside due to produce the inhibiting-combustion substance and the large amounts of gases per fused beforehand which forces the reacting-producing inhibiting combustion substance flows along said axial conduct 13 to the end of the gunpowder to connect with each outlet 161 of said outlet equipment 16 to spray out to the target fire source which achieves the purpose of fire-extinction.

The better structure of the fire-fighting bomb of this invention has the following advantages in comparison with other conventional technologies:

1. This invention utilizes the principle of shoot to aim at the fire source directly and sends the bomb head of fire-fighting onto the center of the fire source exactly to distinct the fire source to achieve the purpose of fire-fighting.

2. This invention utilizes the principles of shoot which makes the fire-fighting staffs no more enters into the fire region and thus reduce the chance of risk happened.

3. This invention has the advantage of elevating the exactness and efficiency largely except for its practical utility.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A better structure of fire-fighting bomb, comprising:
A bomb head, said bomb head is the main structure of fire-fighting bomb;
A strong-acid room, said strong-acid room is settled within said bomb head for containing the reactants of chemical reactions;
An axial conduct, said axial conduct is protruding extending the central axial of the main structure of said bomb head on which there settles a front static stop structure and a rear static stop structure; an inlet conduct, said inlet conduct is connected on said axial conduct and passing into said strong-acid room so that there forms a pass way between said axial conduct and said strong-acid room;
An inlet conduct, said inlet conduct is connected to said axial conduct and passing through said strong acid room such that there forms a pass way between said axial conduct and said strong acid room;
An axial piston, said axial piston is a cavity structure which position is settled within the axial conduct and in connection with the pass way of said axial conduct;
A re-entrance spring which is settled in the front static stop structure of said axial conduct and in connection with the front end of said axial piston;
A position spring which is settled in the rear static stop structure of said axial conduct and in connection with the rear end of said axial piston;
An inlet settled in the tail of said bomb head and in connection with said axial conduct;
Water outlet equipment settled in the tail of said bomb head and in connection with said axial conduct;
A bar settled inside said axial conduct and in connection with said axial piston and convex to the front end of said;
The fire-fighting bomb being completed composite by means of the above-mentioned such that on the moment of explosion by the gunpowder room to produce huge amount of gases on shooting the bomb, utilizing the pressure of huge gas to enhance the reaction time of the reactant inside said fire-fighting bomb so that the reaction is more complete to enhance the efficiency of producing the inhibiting combustion reactant by chemical reaction; wherein when the bomb hits the target object, the product is sprayed to the target fire source to achieve the purpose of fire-fighting.

2. The better structure of fire-fighting bomb as mentioned in claim 1, wherein there is at least one internal space for said bomb head which accommodates the chemical reactant as well as providing the space of chemical reaction.

3. The better structure of fire-fighting bomb as mentioned in claim 1, wherein said strong-acid room is a or a plurality of container free to open or close; it opens the strong acid room by means of the guiding of huge amounts of gases by explosion such that the chemical reactants contained overflows.

4. The better structure of fire-fighting bomb as mentioned in claim 1, wherein there at least settled a gas inlet and a carbon dioxide outlet so that when said gas inlet forms the pass way the gas produced by explosion is guided into said inlet conduct from said axial conduct; and when said carbon dioxide outlet forms the pass way, the inhibiting combustion substance completing combustion flows into said axial conduct.

5. The better structure of fire-fighting bomb as mentioned in claim 1, wherein said inlet conduct could be a single conduct or a plurality of conducts such that huge gases produced on explosion is guided into said strong acid room from said axial conduct.

6. The better structure of fire-fighting bomb as mentioned in claim 1, wherein said axial piston is settled in equilibrium with the space between the front static stop structure and rear static stop structure of said axial conduct by means of the re-entrance spring and the positioning spring.

7. The better structure of fire-fighting bomb as mentioned in claim 1, wherein said re-entrance spring is connected in said front static stop structure and it produced the elastic restore force upon being compressed by said axial piston so that the piston vent on said axial piston is in with the gas inlet of said axial conduct; and the carbon dioxide inlet piston on the axial piston is in stagger with the carbon dioxide outlet of said axial conduct to make the reaction space completely close.

8. The better structure of fire-fighting bomb as mentioned in claim 1, wherein there is at least one gas outlet piston vent and a carbon dioxide inlet vent on said axial piston so that when said gas outlet piston forms the pass way the huge amounts of gases produced on explosion are guided into said inlet conduct from said axial conduct whereas said two carbon dioxide inlet vent forms the pass way, the inhibiting combustion substance complete reaction flows into said axial conduct.

9. The better structure of fire-fighting bomb as mentioned in claim 1, wherein said inlet vent could be single pore or multiple pore to perfuse huge amounts of gases into said axial conduct.

10. The better structure of fire-fighting bomb as mentioned in claim 1, wherein there is at least one outlet pass way for said outlet equipment for spraying the inhibiting combustion substances complete reaction.

11. The better structure of fire-fighting bomb as mentioned in claim 1, wherein said bar is connected to said axial piston and convex to the front of said bomb head and is protrude inside said bomb head compressed by bomb hitting such that the carbon dioxide inlet piston vent on said axial piston is in alignment with the carbon dioxide outlet on said axial conduct to form the pass way whereas the inhibiting combustion substance complete reaction flows into said axial piston and flows to the outlet equipment of said tail of along said axial conduct and future achieves the purpose of spraying out.
